(19) United States
(12) Patent Application Publication
(10) Pub. No.: US 2012/0226552 A1
(43) Pub. Date: Sep. 6, 2012

(54) MEDIATION SYSTEM AND METHOD TO PROVIDE RELEVANT ADVERTISEMENTS

(75) Inventor: Suresh Seenichamy, Santa Clara, CA (US)

(73) Assignee: OPENWAVE SYSTEMS INC., Redwood City, CA (US)

(21) Appl. No.: 13/409,024

(22) Filed: Feb. 29, 2012

Related U.S. Application Data
(60) Provisional application No. 61/448,183, filed on Mar. 1, 2011.

(51) Int. Cl. G06Q 30/02

(52) U.S. Cl. 705/14.53; 705/14.49

(57) ABSTRACT

In one embodiment a method comprises: at an access network, receiving a first request from a request source for an advertisement; requesting request source information related to the request source from an access network knowledge base using identification data of the request source; generating a second request for an advertisement in response to the request source information; and sending the second request to an ad server to obtain a targeted advertisement for the request source based on the request source information.

### CROSS-REFERENCE TO RELATED APPLICATIONS

This application claims the benefit of priority of U.S. Provisional Patent Application No. 61/448,183 entitled “Mediation system and method to provide relevant advertisements” and filed Mar. 1, 2011, which is incorporated by reference herein in its entirety.

### BACKGROUND

When browsing certain webpages, a user may be presented with an advertisement. However, information about the user may not be readily available to servers hosting the webpages. Therefore, it can be difficult to provide a targeted advertisement that is relevant to the user and this in turn decreases the potential revenue generated from such advertisements as the click-through rate is typically a function of the relevance of the advertisement. The less relevant the advertisement, the less likely it is that a user will click through.

### SUMMARY

In one embodiment a method comprises: at an access network: receiving a first request from a request source for an advertisement; requesting request source information related to the request source from an access network knowledge base using identification data of the request source; generating a second request for an advertisement in response to the request source information; and sending the second request to an ad server to obtain a targeted advertisement for the request source based on the request source information.

In another embodiment an access network comprises: a processor; a memory for storing executable instructions, which when executed by the processor perform the steps of: receiving a first request from a request source for an advertisement that is hosted by an ad server; requesting information related to the request source from an access network knowledge base using identification data of the request source; generating a second request for an advertisement in response to the information from the access network knowledge base; and sending the second request to an ad server to obtain a targeted advertisement for the request source based on the request source information.

In a further embodiment of the invention a system comprises: a communications interface configured to receive a first request from a request source for an advertisement; and an advertisement mediation module configured to request information related to the request source from an access network knowledge base using identification data of the request source, said advertisement mediation module further configured to generate a second request for an advertisement in response to the information from the access network knowledge base; wherein the communications interface is configured to send the second request to an ad server to obtain a targeted advertisement for the request source based on the request source information.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of a system for receiving a relevant advertisement from an ad server and for providing the relevant advertisement to a request source in accordance with an embodiment of the invention.

FIG. 2 depicts a schematic diagram of communications between a request source, a content source, an ad mediation module and an ad server through an access network in accordance with an embodiment of the invention.

FIG. 3 depicts a flow diagram of a method for providing targeted advertisements in accordance with an embodiment of the invention.

FIG. 4 depicts a computer that includes a processor, memory, and a communications interface.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

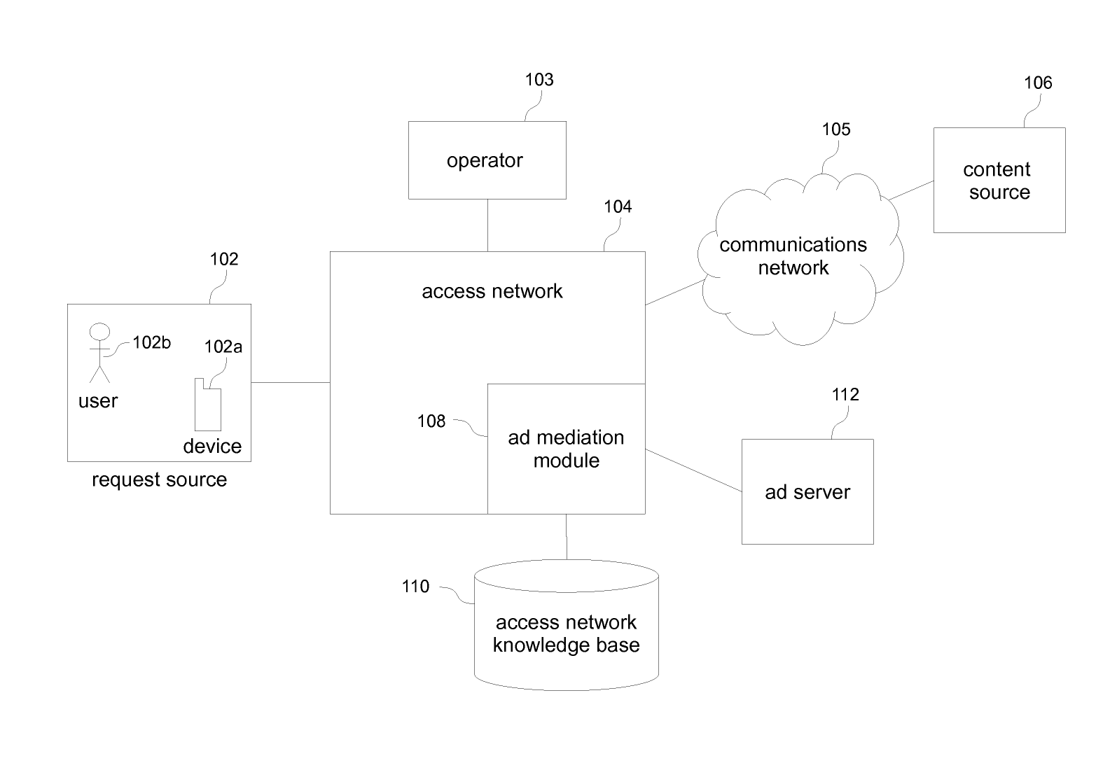

FIG. 1 depicts a system 100 for providing relevant advertisements from an ad server 112 to a request source 102 in accordance with an embodiment of the invention. With respect to FIG. 1, the request source is connected to a content source 106 through an access network 104 and the access network typically communicates with the content source through a communications network 105, such as the Internet. The system of FIG. 1 may include more than one request source and more than one content source connected to each other through the access network. The request source corresponds to a request source device 102a and/or to a user 102b of the request source device.

The request source device 102a is a network enabled device including, without limitation, a mobile phone, smart phone, personal digital assistant (PDA), laptop, tablet, pad, or personal computer (PC). The user 102b is a user of the request source device and the user is typically a subscriber to a wireless communications service (e.g., mobile phone carrier), or a subscriber to an Internet Service Provider (ISP), that operates the access network 104. Oftentimes, a user and a request source device are linked to the same subscriber account. For example, a wireless communications service account links a particular wireless device and a particular user. In one embodiment, the request source device is connected to the access network via a WiFi access point (e.g., from a provider of a free WiFi access or from a home network).

In one embodiment, the request source device 102a is a wireless device that can support various different RF communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that the present disclosure is not limited to the cited wireless communications protocols.

The content source 106 is any device or system that hosts content elements. In one embodiment, the content source is an Internet-connected host or server that is identified by a URI or a URL and that hosts Internet-accessible content elements. Content sources are well known in the field. The content source is, for example, a web server that can be accessed via Hypertext Transfer Protocol (HTTP), Internet Message Access Protocol (IMAP), or File Transfer Protocol (FTP). A content element is any data suitable to be transferred in a networked environment, such as webpages, markup language files, scripting language files, video files, music files, image files or other data files. In a non-limiting example, the content element includes an HTML file. In one non-limiting example, the content element is streamed data (e.g., streamed video and/or audio with ad insertion).

In one embodiment, the request source device 102a accesses the content source 106 by connecting to the Internet via the access network 104. For example, an HTTP request for a content element that is hosted by the content source 106 is generated at the request source device and is transmitted to the content source over a Transmission Control Protocol/Internet Protocol (TCP/IP) connection through the access network and the Internet.

The access network 104 provides a communications interface for the request source device 102a to access the Internet. Typical access networks include wireless service provider networks (e.g., that offer 3G, 4G and/or WiFi access) and ISPs (e.g., that offer broadband DSL, broadband cable modem or dial-up access). A private enterprise network can also serve as the access network if client devices within the private enterprise network can access the Internet through the private enterprise network.

In one embodiment, the access network 104 is a wireless service provider network that provides a wireless communications interface for the request source device 102a (e.g., wireless device such as smartphone, tablet, computer, or laptop). In an embodiment, the wireless service provider network is accessible on a subscription basis (e.g., prepaid or post-paid) as is known in the field. In an embodiment, the wireless service provider network is a closed domain that is accessible only by subscribers (e.g. users of the request source device 102b) that are in good standing with the operator of the wireless service provider network. The wireless service provider network may include a radio access network (not shown) and an Internet gateway (not shown). The radio access network includes one or more base stations to facilitate communications among wireless devices that are within a communication range of the base stations. Each base station has at least one RF transceiver and the base stations communicate with the wireless devices using RF communication signals. The radio access network facilitates network communications among multiple wireless devices within the same wireless service provider network and between wireless devices in other wireless service provider networks and provides interfaces to facilitate communications with other entities, such as a Public Switched Telephone Network (PSTN), a Wide Area Network (WAN), the Internet, Internet servers, hosts, etc., which are outside of the wireless service provider network. In an embodiment, the wireless service provider network is operated by a single wireless service provider, such as, for example, AT&T, VERIZON, T-MOBILE, or SPRINT. In one embodiment, the wireless service provider has exclusive access to and control over the wireless service provider network.

Data signals communicated between the wireless device 102a and the access network 104 include, but are not limited to, analog and/or digital RF signals (i.e., radio waves) for any type of communication mode, including text messaging, multimedia messaging, voice calling, Internet browsing, and video and audio playback. The radio access network can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that the present disclosure is not limited to the cited wireless communications protocols.

The Internet gateway (not shown) of the access network 104 provides a gateway for communications between the wireless devices 102a and Internet-connected hosts and/or servers, which can also be referred to as the “cloud.” The Internet gateway may include a Serving General Packet Radio Service (GPRS) Support Node (SGSN) and a Gateway GPRS Support Node (GGSN). For example, the Internet gateway can be a Wireless Application Protocol (WAP) gateway that converts the WAP protocol used by the access network (such as a wireless service provider network) to the HTTP protocol used by the Internet. In an embodiment, the Internet gateway enables the wireless devices to access multimedia content, such as HTML, compact HTML (cHTML), and extensible HTML (xHTML), which is stored on Internet-connected hosts and/or servers. In this way, the access network provides access to the Internet for its subscribers.

The access network 104 includes or is connected to an ad mediation module 108. The ad mediation module is implemented in hardware and/or software and is configured to provide an advertisement mediation service that, when initiated, provides relevant and targeted advertisements to the request source 102. Because the access network is in the communication path between request sources (e.g., request source 102) and ad servers (e.g., ad server 112), the access network can implement an advertisement mediation protocol that is specific to, for example, the particular ad server involved, the content source of a content element that triggered an advertisement request, or preference settings of the request source. Furthermore, because the access network typically has a subscriber relationship with the request source and therefore holds specific information about the request source, the access network is able to provide relevant advertisements to certain or all of the request sources based on the specific information about the request source. For example, the specific information is proprietary information that is exclusive to the operator of the access network, such as demographic information of the subscriber, billing address of the subscriber, device type of the request source device, subscriber plan information, usage information of the subscriber, access history, etc. In one embodiment, the specific information is exclusive to the operator of the access network in that the information is not publically available for access by, for example, the entities that operate the content source and/or the ad server. In one embodiment, advertisement mediation involves allowing or denying relevant advertisements to be provided using the specific information held by the access network about the request source.

In the example of FIG. 1, the ad mediation module 108 is configured to obtain information about the request source 102 (device 102a and/or user 102b) by querying an access network knowledge base 110, such as a knowledge base that includes information held by an operator 103 of the access network 104. The particular type of information held by the access network knowledge base about the request source device and/or user is typically information that is not normally transmitted within requests and can otherwise not be deduced or derived from a typical content element request (such as a standard HTTP request) and is otherwise not available to the content source 106 and the ad server 112. The access network knowledge base contains information about the request source, such as, in a non-limiting example, information about the request source device (e.g., device type, codecs installed on the device, protocols accepted by the device, browsing history) and/or information about a user of the request source device (e.g., user's age, gender, household income, home/billing address/ZIP code, user behavior data and ad preferences etc).

In the example of FIG. 1, the content source 106 provides a content element (e.g., a webpage) to the request source 102 after a request from the request source for the content element. If the content element includes a placeholder for an advertisement, the request source device 102a will attempt to retrieve the advertisement from an ad server. In the process of retrieving the advertisement, the request source sends a request for the advertisement, the request being destined for an ad server, such as ad server 112 or another ad server. The access network 104 intercepts the request for the advertisement and determines whether advertisement mediation should occur, that is, whether information about the request source should be used to obtain an advertisement that is tailored to the request source. In one embodiment, the request is intercepted because the access network is in the data path between the request source and the content source. The access network is therefore able to leverage information that is exclusive to the operator of the access network and the position of the access network in the data path enables the selection of targeted/relevant advertisements. Furthermore, the access network can unlock the value of the exclusive information without necessarily making the information publically available.

In an embodiment, the request source 102 and/or the operator 103 of the access network 104 can opt in or opt out of the advertisement mediation. In one embodiment, the ad server 112, the content source 106, and/or the request source has to be eligible and has to indicate to the access network that it wishes to participate in the advertisement mediation before advertisement mediation can occur. The ad server, the content source, and/or the request source are, for example, eligible for advertisement mediation if they have signed up for that service. In one embodiment, the advertisement mediation is only initiated if the content source, from which the content element was received, has an agreement with the operator 103 of the access network to provide relevant advertisements to the request source. In a non-limiting example, such an agreement includes a contract between the content source and the operator, whereby financial compensation is provided by the content source to the operator.

In the case where the access network 104 determines that advertisement mediation should occur, the access network directs the ad mediation module 108 to retrieve some information about the request source from the access network knowledge base 110. The access network uses the retrieved information about the request source to send a modified advertisement request to the ad server 112. The ad server 112 may be the same as or different to the ad server for which the original advertisement request from the request source was destined. In an embodiment, the modified advertisement request includes information about the request source, which is, for example, added to the original request for the advertisement. The advertisement mediation service provided by the ad mediation module allows the ad server to provide relevant advertisements that are based on information that is exclusive to and/or held by the access network 104 about the request source and that are targeted to the request source. In one embodiment, the advertisement mediation does not modify the content element beyond providing an advertisement. For example, the advertisement mediation does not modify the layout of a webpage and the targeted advertisement is inserted into the placeholder as chosen by the content source and as agreed to with the ad server. In another embodiment, the layout of the webpage is modified based on the information about the request source in order to optimize advertisement presentation. For example, the advertisement placeholder in the original webpage may be substituted for a splash screen or a banner ad for mobile devices.

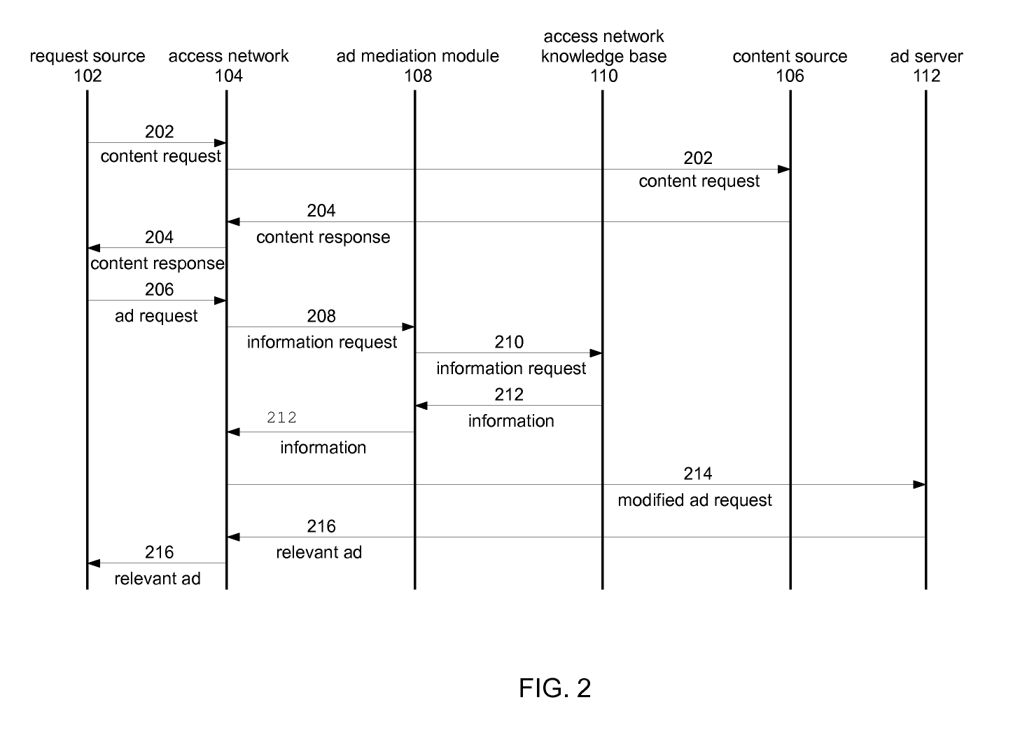

FIG. 2 depicts communications between a request source 102, a content source 106, an ad mediation module 108 and an ad server 112 through an access network 104 in accordance with an embodiment of the invention. In the example of FIG. 2, the request source requests a content element (e.g., a webpage) from the content source via the access network (as indicated by arrows 202). FIG. 2 will now be described with reference to a webpage, although it should be understood that this is merely exemplary and that other content elements are also possible. In response to receiving the request for the webpage, the content source sends the webpage to the request source via the access network (as indicated by arrows 204) or through another network. In the example of FIG. 2, the webpage contains a link (e.g., URL) to an ad server and a placeholder for displaying an advertisement on the webpage. The placeholder triggers a redirect, where the request source automatically generates a request for an advertisement. The request source requests an advertisement using the link (as indicated by arrow 206) and the request for an advertisement is intercepted by the access network, which is in the communication path between the request source and the ad server indicated by the link. The request for the advertisement contains an identifier that uniquely identifies the request source. In a non-limiting example, the identifier is a Mobile Subscriber Integrated Services Digital Network Number (MSISDN), International Mobile Equipment Identity (IMEI), International Mobile Subscriber Identity (IMSI), and/or an IP address. The request for the advertisement sent from the request source to the access network may also contain contextual data, such as location information (e.g., based on a cell-ID or GPS data).

After intercepting the request for the advertisement, the access network 104 directs the ad mediation module 108 to retrieve information about the request source 102 from the access network knowledge base 110 (as indicated by arrow 208). In one embodiment, the access network verifies that the advertisement mediation service should be initiated, whereby the advertisement mediation service includes directing the ad mediation module to retrieve information about the request source. For example, the advertisement mediation service can be initiated when the ad server has previously consented to participate in the advertisement mediation service. In one embodiment, information is requested from the access network knowledge base only if the URL of the ad server identifies a host that is opted in to the advertising program. In another embodiment, the advertisement mediation service is initiated if the redirect (i.e., the advertisement request) from the request source is initiated from a partner content source, that is, from a content source that has an agreement with the access network to receive more relevant advertisements. The content source that triggered the redirect can, for example, be identified from a ‘referer header’ of the advertisement request.

The ad mediation module 108 uses the identifier of the request source 102 to request information about the request source (as indicated by arrow 210) and receives information about the request source (if available) from the access network knowledge base 110 (as indicated by arrows 212). A modified request for the advertisement is then created using the information about the request source. For example, the information about the request source is appended to the original request for the advertisement that was sent from the request source and that was intercepted by the access network. In one embodiment, the modified request for the advertisement includes information about the request source and also contextual data (e.g., location information, an operator ID, an obfuscated subscriber ID for tracking and analytics purposes by the ad server). In one embodiment, the modified request further includes a click through tag that can be used by the ad server to analyze and track click-throughs (e.g., as a click-through rate) of the targeted advertisement (for subsequent visits after the targeted advertisement has been delivered to the request source). Tracking of the click-through tag allows the ad server to improve the selection of targeted ads based on the information about the request source. For example, a high click-through rate for given targeted advertisements for a given demographic information of the request source indicates that the given targeted advertisements are indeed relevant to the request source.

In one embodiment, information about the request source 102, contextual data, and/or click-through tags are referred to as data assets. In a non-limiting example, the information about the request source, the contextual data, the identifier of the request source, an identifier of the access network 104 and/or the click-through tag are added as query parameters to the URL of the ad server 112 in the modified advertisement request, or are included in a header of the advertisement request (e.g., HTTP request). An example of an original URL of the ad server is:

http://ad.doubleclick.net/ad/N4492.Yahoo/B5014254.40;sz=1×1;ord=1298417407537 129?

An example of a modified URL with identifiers added as query parameters are:

http://ad.doubleclick.net/ad/N4492.Yahoo/B5014254.40;sz=1×1;ord=1298417407537 065?opwv_sbr=123;opwv_oper=4

The identifier of the request source and the identifier of the operator can be used by the ad server for tracking purposes and to aid in the selection of the relevant advertisement. The modified request for the advertisement is sent to the ad server (as indicated by arrow 214). Because the ad server now has specific information regarding the request source, the ad server is able to provide a relevant and targeted advertisement to the request source based on the information exclusive to the operator of the access network (as indicated by arrow 216). The relevant advertisement can be chosen by searching for keywords in a list of available advertisements using the information about the request source. The available advertisements may be stored by the ad server or may be retrieved by the ad server from different locations.

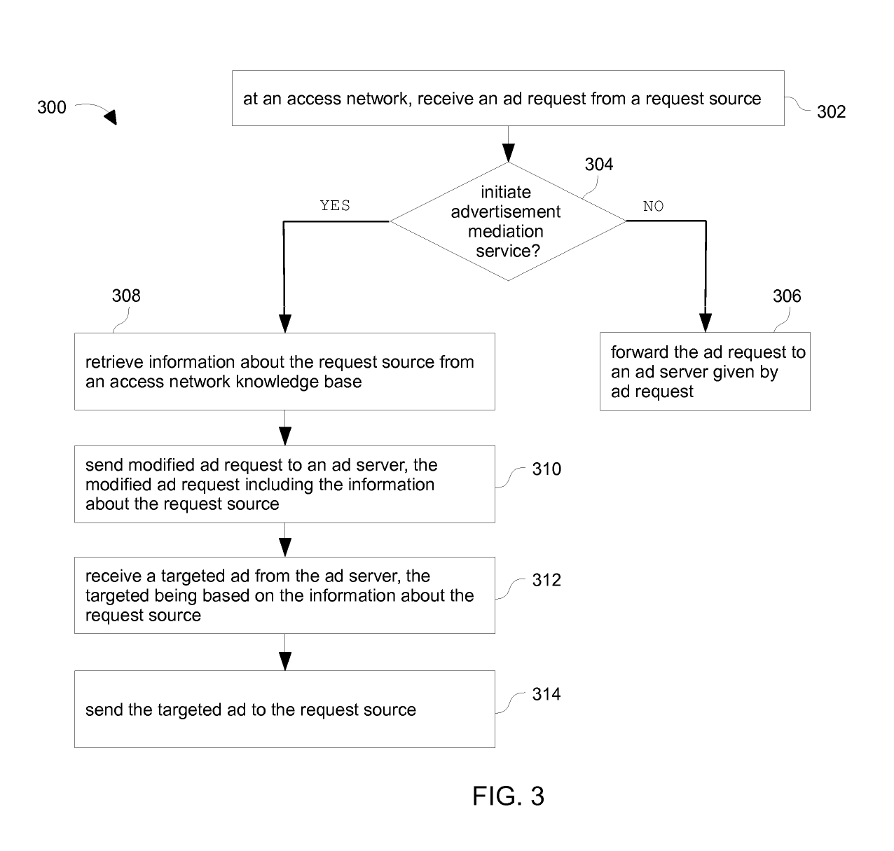

FIG. 3 depicts a flow diagram of a method for providing targeted advertisements in accordance with an embodiment of the invention. At block 302, an advertisement request from a request source 102 is received at an access network 104. Next, at decision point 304, it is determined whether an advertisement mediation service should be initiated. The advertisement mediation service includes receiving a targeted advertisement and providing the targeted advertisement to the request source. If the decision at decision point 304 is no, then the flow diagram continues to block 306, where the advertisement request is forwarded to an ad server 112 given by the advertisement request. If the decision at decision point 304 is yes, then the flow diagram continues to block 308, where the advertisement mediation service retrieves information about the request source from an access network knowledge base 110. Next, at block 310, the advertisement mediation service sends a modified advertisement to an ad server, the modified advertisement request including the information about the request source. Next, at block 312, the advertisement mediation service receives a targeted advertisement from the ad server, the targeted advertisement being based on the information about the request source. Next, at block 314, the advertisement mediation service sends the targeted advertisement to the request source.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital versatile disk (DVD).

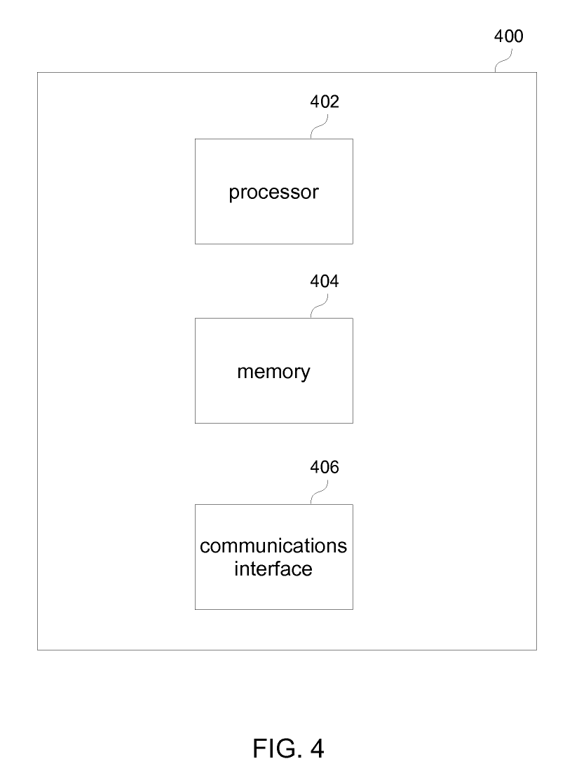

In an embodiment, the functionality of at least some of the components depicted in FIGS. 1 and 2 is performed by a computer that executes computer readable instructions. FIG. 4 depicts a computer 400 that includes a processor 402, memory 404, and a communications interface 406. For example, the access network 104 , the ad mediation module 108, the access network knowledge base 110 and/or the ad server may be implemented in hardware and/or software and are, in a non-limiting example, implemented in a server, such as a file server, database server, web server or any other type of dedicated or shared server. The processor may include a multifunction processor and/or an application-specific processor. Examples of processors include the PowerPC™ family of processors by IBM and the x86 family of processors by Intel. The memory within the computer may include, for example, a non-transitory storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. For example, in the above described embodiments the access network receives the request for the advertisement from the request source, modifies the request in response to the information about the request source and sends the modified request to the ad server. Alternatively, the access network may receive the request for the advertisement from the request source, generate a wholly new request for an advertisement in response to the information about the request source and send the new request to the ad server. The scope of the invention is to be defined by the claims appended hereto and their equivalents.

What is claimed is:

1. A method comprising:
at an access network:
receiving a first request from a request source for an advertisement;
requesting request source information related to the request source from an access network knowledge base using identification data of the request source;
generating a second request for an advertisement in response to the request source information; and
sending the second request to an ad server to obtain a targeted advertisement for the request source based on the request source information.

2. A method according to claim 1, further comprising: modifying the first request to generate the second request.

3. The method of claim 1, wherein the access network is a wireless access network.

4. The method of claim 1 further comprising obtaining the identification data of the request source from the first request, wherein the first request is an HTTP request.

5. The method of claim 1, wherein the access network knowledge base is accessible by the access network and under exclusive control of the access network.

6. The method of claim 1, wherein the request source information is proprietary to the access network.

7. The method of claim 1, wherein the request source information includes demographic information of a subscriber, said subscriber being registered to said request source.

8. The method of claim 7, wherein said demographic information includes at least one of: age, gender, household income, address of the subscriber.

9. The method of claim 6, wherein the request source information includes usage information of the request source, said usage information indicating a browsing pattern of the request source.

10. The method of claim 6, wherein the request source information includes network information, said network information indicating the amount of bandwidth available to the request source.

11. The method of claim 6, wherein the request source information includes the device type of the request source, wherein the advertisement is selected based on the device type.

12. The method of claim 1 further comprising:
prior to the step of receiving the first request from the request source for an advertisement:
receiving a content request from the request source for a content element hosted by a content source, said content element including a placeholder for an advertisement; and
sending the content element to the request source;
wherein the first request is generated in response to the placeholder of the content element.

13. The method of claim 12, wherein the identification data of the request source is obtained from the content request from the request source for a content element.

14. The method of claim 12 further comprising:
prior to the step of requesting information related to the request source:
verifying whether the second request should be generated.

15. The method of claim 14, wherein the step of verifying whether the second request should be generated includes verifying that the content source is a partner content source, wherein an agreement exists between the content source and the access network for the access network to provide a targeted ad.

16. The method of claim 14, wherein the step of verifying whether the second request should be generated includes verifying that the ad server has consented to providing a targeted advertisement.

17. The method of claim 14, wherein the step of verifying whether the second request should be modified includes verifying that the request source has consented to receiving a targeted advertisement.

18. An access network comprising:
a processor;
a memory for storing executable instructions, which when executed by the processor perform the steps of:
receiving a first request from a request source for an advertisement that is hosted by an ad server;
requesting information related to the request source from an access network knowledge base using identification data of the request source;
generating a second request for an advertisement in response to the information from the access network knowledge base; and
sending the second request to an ad server to obtain a targeted advertisement for the request source based on the request source information.

19. A network according to claim 18, wherein the executable instructions, when executed by the processor perform the step of:
modifying the first request to generate the second request.

20. A system comprising:
a communications interface configured to receive a first request from a request source for an advertisement; and
an advertisement mediation module configured to request information related to the request source from an access network knowledge base using identification data of the request source, said advertisement mediation module further configured to generate a second request for an advertisement in response to the information from the access network knowledge base;
wherein the communications interface is configured to send the second request to an ad server to obtain a targeted advertisement for the request source based on the request source information.

21. A system according to claim 20, wherein the advertisement mediation module is further configured to:
modify the first request to generate the second request.
